(19) United States
(12) Patent Application Publication
(10) Pub. No.: US 2022/0306895 A1
(43) Pub. Date: Sep. 29, 2022

(54) POLYIMIDE PRECURSOR SOLUTION, POROUS POLYIMIDE FILM PRODUCTION METHOD, AND POROUS POLYIMIDE FILM

(71) Applicant: FUJIFILM BUSINESS INNOVATION CORP., Tokyo (JP)

(72) Inventors: Shigeru SEITOKU, Kanagawa (JP); Kosaku YOSHIMURA, Kanagawa (JP); Hidekazu HIROSE, Kanagawa (JP); Hajime SUGAHARA, Kanagawa (JP); Kosuke NAKADA, Kanagawa (JP); Satoshi YOSHIDA, Kanagawa (JP)

(73) Assignee: FUJIFILM BUSINESS INNOVATION CORP., Tokyo (JP)

(21) Appl. No.: 17/699,991

(22) Filed: Mar. 21, 2022

(30) Foreign Application Priority Data
Mar. 25, 2021 (JP) 2021-052443
Nov. 16, 2021 (JP) 2021-186558

(51) Int. Cl. C09D 179/08; C08G 73/10; C08J 9/24; C08J 9/00

(52) U.S. Cl. CPC C09D 179/08; C08G 73/1067; C08G 73/1032; C08J 9/24; C08J 9/0061; C08J 2379/08; C08J 2425/08

(57) ABSTRACT

A polyimide precursor solution contains a polyimide precursor, particles, and a water-based solvent that contains an amine compound (A), an organic solvent (B) other than the amine compound (A) and amide compounds, and water, in which a boiling point of the organic solvent (B) is higher than a boiling point of the amine compound (A), and is 200° C. or higher and 300° C. or lower.

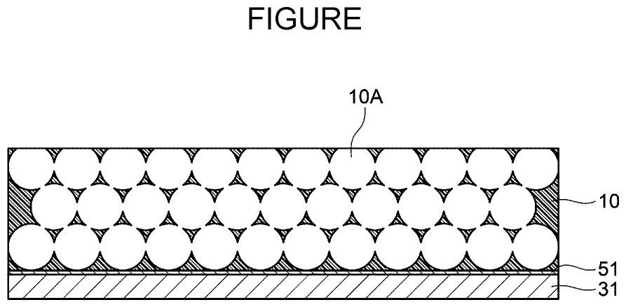

### CROSS-REFERENCE TO RELATED APPLICATIONS

This application is based on and claims priority under 35 USC 119 from Japanese Patent Application No. 2021-052443 filed Mar. 25, 2021 and Japanese Patent Application No. 2021-186558 filed Nov. 16, 2021.

### BACKGROUND

### (i) Technical Field

The present disclosure relates to a polyimide precursor solution, a porous polyimide film production method, and a porous polyimide film.

### (ii) Related Art

Japanese Unexamined Patent Application Publication No. 2020-104105 proposes a porous film production method that includes a step of preparing a porous film-forming composition that contains fine particles and at least one resin component selected from the group consisting of polyamic acids, polyimides, polyamide imide precursors, polyamide imides, and polyether sulfones, the step including a dispersing step that involves using a dispersing device equipped with a pressure device that pressurizes a slurry containing the fine particles and a flow channel having a cross-sectional area of 1960 μm² or more and 785000 μm² or less in order to allow the slurry pressured to 50 MPa or higher to pass the flow channel so as to disperse the fine particles.

### SUMMARY

Aspects of non-limiting embodiments of the present disclosure relate to a polyimide precursor solution, which contains a polyimide precursor, particles, and a water-based solvent that contains an amine compound (A), an organic solvent (B) other than the amine compound (A) and amide compounds, and water, and from which a polyimide film having a low resistance value is obtained compared to when the boiling point of the organic solvent (B) is lower than the boiling point of the amine compound (A), or is lower than 200° C. or higher than 300° C.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a polyimide precursor solution containing a polyimide precursor, particles, and a water-based solvent that contains an amine compound (A), an organic solvent (B) other than the amine compound (A) and amide compounds, and water, in which a boiling point of the organic solvent (B) is higher than a boiling point of the amine compound (A), and is 200° C. or higher and 300° C. or lower.

### BRIEF DESCRIPTION OF THE DRAWINGS

Exemplary embodiments of the present disclosure will be described in detail based on the following FIGURE, wherein:

FIGURE is a diagram illustrating one example of a porous polyimide film according to an exemplary embodiment.

### DETAILED DESCRIPTION

Hereinafter, some exemplary embodiments of the present disclosure are described.

These descriptions and examples are merely illustrative and do not limit the scope of the exemplary embodiments.

In this description, in numerical ranges described stepwise, the upper limit or the lower limit of one numerical range may be substituted with an upper limit or a lower limit of a different numerical range also described stepwise. In addition, in any numerical range described in the description, the upper limit or the lower limit of the numerical range may be substituted with a value indicated in Examples.

In this description, the term “step” indicates not only an independent step but also any feature that achieves the intended purpose of a certain step although such a feature may not be clearly distinguishable from other steps.

Each component may contain more than one corresponding substances.

When the amount of a component in a composition is described and when there are two or more substances that correspond to that component in the composition, the amount is the total amount of the two or more substances in the composition unless otherwise noted.

In this description, the “boiling point” refers to a boiling point at atmospheric pressure (101.3 kPa) unless otherwise noted.

In this exemplary embodiment, the “film” not only refers to those typically referred to as films but also those which are typically referred to as sheets.

### Polyimide Precursor Solution

A polyimide precursor solution according to an exemplary embodiment contains a polyimide precursor, particles, and a water-based solvent that contains an amine compound (A), an organic solvent (B) other than the amine compound (A) and amide compounds, and water.

The boiling point of the organic solvent (B) is higher than the boiling point of the amine compound (A), and is 200° C. or higher and 300° C. or lower.

Due to the aforementioned features, the polyimide precursor solution according to this exemplary embodiment contributes to forming a polyimide film having a low resistance value. The reason for this is presumably as follows.

Depending on the usage, a porous polyimide film is to have a low resistance. One way to decrease the resistance value of a porous polyimide film is, for example, increasing the ratio of open pores.

Here, a porous polyimide film is produced by applying a particle-containing polyimide precursor solution to a substrate to form a coating film, drying the coating film to form a dry film, firing the dry film, and removing the particles. In order to increase the ratio of the open pores in the porous polyimide film, the dispersibility of the particles during firing of the dry film may be increased so that the particles are substantially evenly dispersed within the dry film. However, when the dry film is fired, for example, particles may aggregate in the dry film or settle within the coating film due to the decreased flowability of the particles in the dry film, and this inhibits formation of a porous polyimide film having a high open pore ratio.

The polyimide precursor solution according to the exemplary embodiment contains a water-based solvent that contains an organic solvent (B). In addition, the boiling point of the organic solvent (B) is higher than the boiling point of the amine compound (A), and is 200° C. or higher and 300° C. or lower. Here, the amine compound (A) is a compound that catalyzes the imidization reaction, and gradually evaporates from the dry film during firing. Since the organic solvent (B), which has a higher boiling point than the amine compound (A), is contained, the organic solvent (B) stays within the coating film as long as the amine compound (A) serving as a catalyst is present in the dry film. In other words, when the dry film is being fired, the organic solvent (B) is present in the dry film while the imidization is in progress; thus, the flowability of the particles is likely to stay high from after formation of the dry film until completion of imidization. Moreover, since the boiling point of the organic solvent (B) is 200° C. or higher and 300° C. or lower, the volatility of the organic solvent (B) is decreased, and the flowability of the particles is further likely to stay high from after formation of the dry film until completion of the imidization. Thus, a porous polyimide film obtained from the polyimide precursor solution of this exemplary embodiment tends to have an increased open pore ratio.

Presumably due to the aforementioned features, the polyimide precursor solution according to this exemplary embodiment contributes to forming a polyimide film having a low resistance value.

Here, in the polyimide precursor solution of the exemplary embodiment, the difference between the boiling point of the amine compound (A) and the boiling point of the organic solvent (B) (boiling point of organic solvent (B)−boiling point of amine compound (A)) may be 10° C. or more and 200° C. or less.

Due to the aforementioned features, the polyimide precursor solution according to this exemplary embodiment contributes to forming a polyimide film having a low resistance value. The reason for this is presumably as follows.

The polyimide precursor solution according to the exemplary embodiment contains a water-based solvent that contains an organic solvent (B). In addition, since the difference between the boiling point of the amine compound (A) and the boiling point of the organic solvent (B) (boiling point of organic solvent (B)−boiling point of amine compound (A)) is 10° C. or more and 200° C. or less, the organic solvent (B) has a higher boiling point than the amine compound (A). In other words, when imidization is in progress during firing, the organic solvent (B) is present in the dry film, and thus the flowability of the particles in the dry film is likely to stay high. Thus, the flowability of the particles is likely to stay high from after formation of the dry film until completion of the imidization. Moreover, since the difference between the boiling point of the amine compound (A) and the boiling point of the organic solvent (B) is within the aforementioned numerical range, the volatility of the organic solvent (B) is decreased, and the flowability of the particles is further likely to stay high from after formation of the dry film until completion of the imidization. Thus, a porous polyimide film obtained from the polyimide precursor solution of this exemplary embodiment tends to have an increased open pore ratio.

Thus, it is assumed that the polyimide precursor solution of the exemplary embodiment contributes to forming a polyimide film having a low resistance value since the difference between the boiling point of the amine compound (A) and the boiling point of the organic solvent (B) (boiling point of organic solvent (B)−boiling point of amine compound (A)) is set to be 10° C. or more and 200° C. or less.

### Polyimide Precursor

The polyimide precursor is obtained by polymerizing a tetracarboxylic dianhydride and a diamine compound. Specifically, the polyimide precursor is a resin (in other words, a polyamic acid) that has a repeating unit represented by general formula (I).

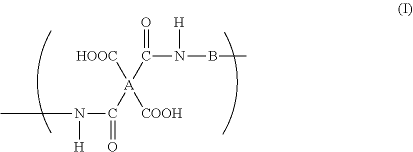

(In general formula (I), A represents a tetravalent organic group, and B represents a divalent organic group.)

Here, the tetravalent organic group represented by A in general formula (I) is a residue obtained by removing four carboxyl groups from the raw material, the tetracarboxylic dianhydride.

Meanwhile, the divalent organic group represented by B is a residue obtained by removing two amino groups from the raw material, the diamine compound.

In other words, the polyimide precursor having a repeating unit represented by general formula (I) is a polymer between a tetracarboxylic dianhydride and a diamine compound.

Examples of the tetracarboxylic dianhydride include aromatic tetracarboxylic dianhydrides and aliphatic tetracarboxylic dianhydrides, and aromatic tetracarboxylic dianhydrides are preferable. In other words, the tetravalent organic group represented by A in general formula (I) may be an aromatic organic group.

Examples of the aromatic tetracarboxylic dianhydrides include pyromellitic dianhydride, 3,3′,4,4′-benzophenonetetracarboxylic dianhydride, 3,3′,4,4′-diphenylsulfone tetracarboxylic dianhydride, 4,4′-oxydiphthalic anhydride, 3,4′-oxydiphthalic anhydride, 3,3′,4,4′-biphenyltetracarboxylic dianhydride, 2,3,3′,4′-biphenyltetracarboxylic dianhydride, 4,4′-(hexafluoroisopropylidene)diphthalic anhydride, 2,2-bis(3,4-dicarboxyphenyl)propane dianhydride, bis(3,4-dicarboxyphenyl)methane dianhydride, 1,4-bis(3,4-dicarboxyphenoxy)benzene dianhydride, 1,4-bis(2,3-dicarboxyphenoxy) benzene dianhydride, p-phenylene bis(trimellitate anhydride), m-phenylenebis(trimellitate anhydride), 2,2-bis[4-(3,4-dicarboxyphenoxy)phenyl]propane dianhydride, naphthalene-1,4,5,8-tetracarboxylic dianhydride, naphthalene-2,3,6,7-tetracarboxylic dianhydride, 9,9-bis(3,4-dicarboxyphenyl)fluorene dianhydride, 4,4′-diphenyl ether bis(trimellitate anhydride), 4,4′-diphenylmethanebis(trimellitate anhydride), 4,4′-bis(3,4-dicarboxyphenoxy)diphenylsulfide dianhydride, 4,4′-bis(3,4-dicarboxyphenoxy)diphenylsulfone dianhydride, 4,4′-bis(3,4-dicarboxyphenoxy)diphenyl ether dianhydride, 2,2-bis(4-hydroxyphenyl)propanebis(trimellitate anhydride), p-terphenyltetracarboxylic dianhydride, and m-terphenyltetracarboxylic dianhydride.

Examples of the aliphatic tetracarboxylic dianhydrides include aliphatic or alicyclic tetracarboxylic dianhydrides such as butanetetracarboxylic dianhydride, 1,2,3,4-cyclobutanetetracarboxylic dianhydride, 1,3-dimethyl-1,2,3,4-cyclobutanetetracarboxylic dianhydride, 1,2,3,4-cyclopentanetetracarboxylic dianhydride, 2,3,5-tricarboxycyclopentylacetic dianhydride, 3,5,6-tricarboxynorbornane-2-acetic dianhydride, 2,3,4,5-tetrahydrofuran tetracarboxylic dianhydride, 5-(2,5-dioxotetrahydrofuryl)-3-methyl-3-cyclohexene-1,2-dicarboxylic dianhydride, and bicyclo[2,2,2]-octo-7-ene-2,3,5,6-tetracarboxylic dianhydride; and aromatic ring-containing aliphatic tetracarboxylic dianhydrides such as 1,3,3a,4,5,9b-hexahydro-5-(tetrahydro-2,5-dioxo-3-furanyl)-naphtho[1,2-c]fran-1,3-dione, 1,3,3a,4,5,9b-hexahydro-5-methyl-5-(tetrahydro-2,5-dioxo-3-franyl)-naphtho[1,2-c]fran-1,3-dione, and 1,3,3a,4,5,9b-hexahydro-8-methyl-5-(tetrahydro-2,5-dioxo-3-franyl)-naphtho[1,2-c]furan-1,3-dione.

Among these, aromatic tetracarboxylic dianhydrides are preferable as the tetracarboxylic dianhydride, and, specifically, pyromellitic dianhydride, 3,3′,4,4′-benzophenonetetracarboxylic dianhydride, 4,4′-oxydiphthalic anhydride, 3,3′,4,4′-biphenyltetracarboxylic dianhydride, and 2,3,3′,4′-biphenyltetracarboxylic dianhydride are preferable, pyromellitic dianhydride, 3,3′,4,4′-biphenyltetracarboxylic dianhydride, and 3,3′,4,4′-benzophenone tetracarboxylic dianhydride are more preferable, and 3,3′,4,4′-biphenyltetracarboxylic dianhydride is particularly preferable.

These tetracarboxylic dianhydrides may be used alone or in combination.

When tetracarboxylic dianhydrides are used in combination, two or more aromatic tetracarboxylic dianhydrides or two or more aliphatic tetracarboxylic dianhydrides may be used in combination, or a combination of an aromatic tetracarboxylic dianhydride and an aliphatic tetracarboxylic dianhydride may be used.

Meanwhile, a diamine compound is a diamine compound having two amino groups in a molecular structure. The diamine compound may be an aromatic diamine compound or an aliphatic diamine compound, but is preferably an aromatic diamine compound. In other words, the divalent organic group represented by B in general formula (I) may be an aromatic organic group.

Examples of the diamine compound include aromatic diamine compound such as p-phenylenediamine, m-phenylenediamine, 4,4′-diaminodiphenylmethane, 4,4′-diaminodiphenylethane, 4,4′-diaminodiphenyl ether, 4,4′-diaminodiphenylsulfide, 4,4′-diaminodiphenylsulfone, 1,5-diaminonaphthalene, 3,3-dimethyl-4,4′-diaminobiphenyl, 5-amino-1-(4′-aminophenyl)-1,3,3-trimethylindan, 6-amino-1-(4′-aminophenyl)-1,3,3-trimethylindan, 4,4′-diaminobenzanilide, 3,5-diamino-3′-trifluoromethylbenzanilide, 3,5-diamino-4′-trifluoromethylbenzanilide, 3,4′-diaminodiphenyl ether, 2,7-diaminofluorene, 2,2-bis(4-aminophenyl)hexafluoropropane, 4,4′-methylene-bis(2-chloroaniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 4,4′-diamino-2,2′-bis(trifluoromethyl)biphenyl, 2,2-bis[4-(4-aminophenoxy)phenyl]propane, 2,2-bis[4-(4-aminophenoxy)phenyl]hexafluoropropane, 1,4-bis(4-aminophenoxy)benzene, 4,4′-bis(4-aminophenoxy)-biphenyl, 1,3′-bis(4-aminophenoxy)benzene, 9,9-bis(4-aminophenyl)fluorene, 4,4′-(p-phenyleneisopropylidene)bisaniline, 4,4′-(m-phenyleneisopropylidene)bisaniline, 2,2′-bis[4-(4-amino-2-trifluoromethylphenoxy)phenyl]hexafluoropropane, and 4,4′-bis[4-(4-amino-2-trifluoromethyl)phenoxy]-octafluorobiphenyl; aromatic diamine compounds having two amino groups bonded to an aromatic ring and heteroatoms other than the nitrogen atoms in these amino groups, such as diaminotetraphenylthiophene; and aliphatic diamine compounds and alicyclic diamine compounds such as 1,1-metaxylylenediamine, 1,3-propanediamine, tetramethylenediamine, pentamethylenediamine, octamethylenediamine, nonamethylenediamine, 4,4-diaminoheptamethylenediamine, 1,4-diaminocyclohexane, isophoronediamine, tetrahydrodicyclopentadienylenediamine, hexahydro-4,7-methanoindanylenedimethylenediamine, tricyclo[6,2,1,0^{2.7}]-undecylenedimethyldiamine, and 4,4′-methylenebis(cyclohexylamine).

Among these, aromatic diamine compounds are preferable as the diamine compound, and, specifically, for example, p-phenylenediamine, m-phenylenediamine, 4,4′-diaminodiphenylmethane, 4,4′-diaminodiphenyl ether, 3,4′-diaminodiphenyl ether, 4,4′-diaminodiphenylsulfide, and 4,4′-diaminodiphenylsulfone are preferable, and 4,4′-diaminodiphenyl ether and p-phenylenediamine are particularly preferable.

These diamine compounds may be used alone or in combination. When diamine compounds are used in combination, two or more aromatic diamine compounds or two or more aliphatic diamine compounds may be used in combination, or a combination of an aromatic diamine compound and an aliphatic diamine compound may be used.

In order to adjust the handling property and mechanical properties of the polyimide to be obtained, copolymerization may be performed by using two or more tetracarboxylic dianhydrides and/or diamine compounds in some cases.

Examples of the combination for the copolymerization include copolymerization between a tetracarboxylic dianhydride and/or a diamine compound that has one aromatic ring in the chemical structure and a tetracarboxylic dianhydride and/or a diamine compound that has two or more aromatic rings in the chemical structure; and copolymerization between an aromatic tetracarboxylic dianhydride and/or a diamine compound and a carboxy dianhydride and/or a diamine compound that has a flexible linking group such as an alkylene group, an alkyleneoxy group, and a siloxane group.

The number average molecular weight of the polyimide precursor is preferably 1000 or more and 150000 or less, more preferably 5000 or more and 130000 or less, and yet more preferably 10000 or more and 100000 or less.

When the number average molecular weight of the polyimide precursor is within the aforementioned range, the decrease in the solubility of the polyimide precursor in a solvent is suppressed, and the film forming property is readily ensured.

The number average molecular weight of the polyimide precursor is measured by gel permeation chromatography (GPC) under the following measurement conditions.
Column: TOSOH TSKgela-M (7.8 mm I.D×30 cm)
Eluent: DMF (dimethylformamide)/30 mM LiBr/60 mM phosphoric acid
Flow rate: 0.6 mL/min
Injection amount: 60 μL
Detector: RI (refractive index detector)

The polyimide precursor content (or concentration) relative to the total of the polyimide precursor solution is preferably 0.1 mass % or more and 40 mass % or less, more preferably 0.5 mass % or more and 25 mass % or less, and yet more preferably 1 mass % or more and 20 mass % or less.

### Particles

Particles refer to those particles in a dispersed state but not in a dissolved state.

The material for the particles is not particularly limited as long as the particles do not dissolve in the polyimide precursor solution of the exemplary embodiment, and the material is roughly categorized into resin particles and inorganic particles described below.

In this exemplary embodiment, “particles do not dissolve” means that, at 25° C., the particles do not dissolve in a subject liquid (specifically, the water-based solvent contained in the polyimide precursor solution) or dissolve within 3 mass % of the subject liquid.

Moreover, the particles may remain in the polyimide film produced by using the polyimide precursor solution of this exemplary embodiment, or may be removed from the polyimide film produced.

The volume average particle diameter D50v of the particles is not particularly limited. The volume average particle diameter D50v of the particles may be, for example, 0.05 μm or more and 10 μm or less. The lower limit of the volume average particle diameter D50v of the particles may be 0.2 μm or more, 0.3 μm or more, 0.4 μm or more, or 0.5 μm or more. The upper limit of the volume average particle diameter D50v of the particles may be 7 μm or less, 5 μm or less, 3 μm or less, or 2 μm or less.

The volume particle size distribution index (GSDv) of the particles is preferably 1.30 or less, more preferably 1.25 or less, and most preferably 1.20 or less.

The particle size distribution of the particles in the polyimide precursor solution according to the exemplary embodiment is measured by the following method.

A composition to be measured is diluted, and the particle size distribution of the particles in the solution is measured by using a Coulter Counter LS13 (produced by Beckman Coulter Inc.). On the basis of the measured particle size distribution, a volume-cumulative distribution is plotted from the small diameter side relative to the split particle size ranges (or channels) to measure the particle size distribution.

In the volume-cumulative distribution plotted from the small diameter size, the particle diameter at a cumulative percentage of 16% is assumed to be a volume particle diameter D16v, the particle diameter at a cumulative percentage of 50% is assumed to be the volume average particle diameter D50v, and the particle diameter at a cumulative percentage of 84% is assumed to be the volume particle diameter D84v.

The volume particle size distribution index (GSDv) of the particles is calculated by (D84v/D16v)^{1/2} from the particle size distribution obtained by the method described above.

When it is difficult for the aforementioned method to measure the particle size distribution of the particles in the polyimide precursor solution of this exemplary embodiment, another method, such as a dynamic light scattering method, may be used for the measurement.

The particles may have a spherical shape.

When a porous polyimide film is produced by using spherical particles and removing the particles from the polyimide film, a porous polyimide film having spherical pores is obtained.

In this exemplary embodiment, “spherical” for the particles means that the particles are either spherical or substantially spherical (shape close to a sphere).

Specifically, “spherical” means that the ratio of the particles that have a long axis-to-short axis ratio (long axis/short axis) of 1 or more and less than 1.5 is more than 80%. The ratio of the particles that have a long axis-to-short axis ratio (long axis/short axis) of 1 or more and less than 1.5 is preferably more than 90%. The closer the long axis-to-short axis ratio is to 1, the more spherical the particles.

The particles may be resin particles or inorganic particles, but are preferably resin particles for the following reasons.

The resin particles and the polyimide precursor are both organic materials, and, thus, compared to when inorganic particles are used, the particle dispersibility in the coating film of the polyimide precursor solution, the interface adhesion between the particles and the polyimide precursor, and the like are likely to improve. In the imidization step in the polyimide film production, the resin particles are likely to absorb volume shrinkage; thus, cracking that occurs in the polyimide film due to the volume shrinkage is suppressed.

Hereinafter, specific materials for the resin particles and inorganic particles are described.

### Resin Particles

The resin particles may be any resin particles that do not dissolve in the polyimide precursor solution (specifically, the water-based solvent contained in the polyimide precursor solution). The resin particles may be composed of a resin other than polyimide.

Specific examples of the resin particles include particles of vinyl resins such as polystyrenes, poly(meth)acrylic acids, polyvinyl acetate, polyvinyl alcohol, polyvinyl butyral, and polyvinyl ether; condensation resins such as polyesters, polyurethanes, and polyamides; hydrocarbon resins such as polyethylene, polypropylene, and polybutadiene; and fluororesins such as polytetrafluoroethylene and polyvinyl fluoride.

Here, “(meth)acryl” refers to both “acryl” and “methacryl”. (Meth)acrylic acids include (meth)acrylic acid, (meth)acrylates, and (meth)acrylamides.

The resin particles may or may not be crosslinked.

When the resin particles are vinyl resin particles, the resin particles are obtained by addition polymerization of a monomer.

Examples of the monomer used to obtain a vinyl resin include styrenes having styrene skeletons, such as styrene, alkyl-substituted styrene (for example, α-methylstyrene, 2-methylstyrene, 3-methylstyrene, 4-methylstyrene, 2-ethylstyrene, 3-ethylstyrene, and 4-ethylstyrene), halogen-substituted styrene (for example, 2-chlorostyrene, 3-chlorostyrene, and 4-chlorostyrene), and vinyl naphthalene; (meth)acrylates such as methyl (meth)acrylate, ethyl (meth)acrylate, n-propyl (meth)acrylate, n-butyl (meth)acrylate, lauryl (meth)acrylate, and 2-ethylhexyl (meth)acrylate; vinyl nitriles such as acrylonitrile and methacrylonitrile; vinyl ethers such as vinyl methyl ether and vinyl isobutyl ether; vinyl ketones such as vinyl methyl ketone, vinyl ethyl ketone, and vinyl isopropenyl ketone; acids such as (meth)acrylic acid, maleic acid, cinnamic acid, fumaric acid, and vinyl sulfonic acid; and bases such as ethyleneimine, vinylpyridine, and vinylamine.

The vinyl resin may be a resin obtained by using one of these monomers alone, or may be a copolymer resin obtained by using two or more of these monomers.

Examples of another monomer that can be used in combination include monofunctional monomers such as vinyl acetate, difunctional monomers such as divinylbenzene, ethylene glycol dimethacrylate, nonane diacrylate, and decanediol diacrylate, and polyfunctional monomers such as trimethylolpropane triacrylate and trimethylolpropane trimethacrylate.

By using a difunctional monomer and a polyfunctional monomer in combination, crosslinked resin particles are obtained.

From the production property and the suitability for the particle removing step described below, the resin particles are preferably polystyrene, poly(meth)acrylic acid, or polyester resin particles, and more preferably polystyrene, styrene-(meth)acrylic acid copolymer, or poly(meth)acrylic acid resin particles.

Here, a polystyrene is a resin that contains a constituent unit derived from a styrene monomer (in other words, a monomer having a styrene skeleton). More specifically, a polystyrene preferably contains 30 mol % or more and more preferably 50 mol % or more of the aforementioned constituent unit relative to a total of 100 mol % of all constituent units of the resin.

In addition, a poly(meth)acrylic acid refers to a methacrylic resin or an acrylic resin, and is a resin that contains a constituent unit derived from a (meth)acrylic monomer (in other words, a monomer having a (meth)acryloyl skeleton). More specifically, a poly(meth)acrylic acid preferably contains a total of 30 mol % or more and more preferably a total of 50 mol % or more of the constituent units derived from a (meth)acrylic acid and/or a methacrylate relative to a total of 100 mol % of the polymer composition.

A polyester refers to a resin that is obtained by polycondensation between a polycarboxylic acid and a polyhydric alcohol and that contains ester bonds in the main chain.

From the viewpoint of ease of suppressing movement of particles, the difference in specific gravity between the resin particles and the liquid may be small, and thus, the resin particles are preferably resin particles formed of a resin containing a styrene-derived constituent unit, and more preferably contain 30 mol % or more, yet more preferably 50 mol % or more, still more preferably 80 mol % or more, and particularly preferably 100 mol % of the styrene-derived constituent unit relative to a total of 100 mol % of all constituent units of the resin.

These resin particles may be used alone or in combination.

The resin particles may retain its particle shape during the process of producing the polyimide precursor solution of the exemplary embodiment and the process of applying the polyimide precursor solution of the exemplary embodiment to form a coating film and drying the coating film in producing a polyimide film (in other words, the process that precedes the removal of the resin particles). From these viewpoints, the glass transition temperature of the resin particles is preferably 60° C. or higher, more preferably 70° C. or higher, and yet more preferably 80° C. or higher.

The glass transition temperature is determined from a differential scanning calorimetry (DSC) curve obtained by DSC, more specifically, according to the method described in the “extrapolated glass transition onset temperature” described in the method for determining the glass transition temperature in JIS K 7121:1987 “Testing Methods for Transition Temperatures of Plastics”.

### Inorganic Particles

Specific examples of the inorganic particles include silica (silicon dioxide) particles, magnesium oxide particles, alumina particles, zirconia particles, calcium carbonate particles, calcium oxide particles, titanium dioxide particles, zinc oxide particles, and cerium oxide particles.

As mentioned above, the particles may have a spherical shape. From such a viewpoint, the inorganic particles are preferably silica particles, magnesium oxide particles, calcium carbonate particles, titanium dioxide particles, or alumina particles, more preferably silica particles, titanium dioxide particles, or alumina particles, and yet more preferably silica particles.

These inorganic particles may be used alone or in combination.

When the wettability and the dispersibility of the inorganic particles for the solvent in the polyimide precursor solution of the exemplary embodiment are insufficient, the inorganic particles may be surface-modified as necessary.

Examples of the surface modification method for inorganic particles include a method that involves treating particles with an organic group-containing alkoxysilane, such as a silane coupling agent, and a method that involves coating the particles with an organic acid such as oxalic acid, citric acid, or lactic acid.

The particle content may be determined according to the polyimide film usage, and is preferably 0.1 mass % or more and 20 mass % or less, more preferably 0.5 mass % or more and 20 mass % or less, and yet more preferably 1 mass % or more and 20 mass % or less relative to a total mass of the polyimide precursor solution of the exemplary embodiment.

In the polyimide precursor solution of the exemplary embodiment, the particle content relative to the solid content in the polyimide precursor solution is preferably 10 vol % or more and 150 vol % or less, more preferably 20 vol % or more and 140 vol % or less, yet more preferably 30 vol % or more and 130 vol % or less, and particularly preferably 30 vol % or more and 80 vol % or less.

By adjusting the particle content to be within the aforementioned range, the abundance of particles in the coating film obtained by applying the polyimide precursor increases, and the inter-particle distance in the coating film is likely to decrease in producing a porous polyimide film. Thus, a porous polyimide film obtained by drying and firing the coating film is likely to have a high open pore ratio, and thus a low resistance value.

### Water-Based Solvent

The water-based solvent contains an amine compound (A), an organic solvent (B) other than the amine compound (A) and amide compounds, and water.

### Amine Compound (A)

The amine compound (A) increases the solubility of the polyimide precursor in water, and has a catalytic action when the polyimide precursor is imidized (in other words, dehydration ring-closure), and thus a polyimide precursor dry film and a polyimide film having high strength can be obtained.

Examples of the amine compound (A) include primary amine compounds, secondary amine compounds, and tertiary amine compounds.

Examples of the primary amine compounds include methylamine, ethylamine, n-propylamine, isopropylamine, 2-ethanolamine, and 2-amino-2-methyl-1-propanol.

Examples of the secondary amine compounds include dimethylamine, 2-(methylamino)ethanol, 2-(ethylamino)ethanol, and morpholine.

The amine compound (A) may be a tertiary amine compound.

Examples of the tertiary amine compounds include acyclic amine compounds and cyclic amine compounds.

Examples of the acyclic amine compounds include trialkylamines (alkyl group-containing tertiary amine compounds) and tertiary amino alcohols (tertiary amine compounds having alkyl chains and hydroxy groups).

Examples of the cyclic amine compounds include N-substituted piperazine (an amine compound having a piperazine skeleton), N-substituted morpholine (an amine compound having a morpholine skeleton), isoquinolines (amine compounds having isoquinoline skeletons), pyridines (amine compounds having pyridine skeletons), pyrimidines (amine compounds having pyrimidine skeletons), pyrazines (amine compounds having pyrazine skeletons), triazines (amine compounds having triazine skeletons), N-substituted imidazole (an amine compound having an imidazole skeleton), and polypyridine.

The number of carbon atoms in the acyclic amine compound is not particularly limited, but is preferably 3 or more and 18 or less, more preferably 3 or more and 15 or less, and yet more preferably 3 or more and 12 or less.

The number of carbon atoms in the cyclic amine compound is not particularly limited, but is preferably 3 or more and 10 or less, more preferably 3 or more and 9 or less, and yet more preferably 3 or more and 8 or less.

From the viewpoint of obtaining a polyimide precursor dry film and a polyimide film having high strength, the amine compound (A) may be at least one compound selected from the group consisting of N-substituted morpholines, trialkylamines, tertiary amino alcohols, and N-substituted imidazoles.

The substituent of the N-substituted morpholine may be an alkyl group.

The number of carbon atoms in the alkyl group is preferably 1 or more and 6 or less, more preferably 1 or more and 5 or less, and yet more preferably 1 or more and 4 or less.

Specific examples of the N-substituted morpholine include N-methylmorpholine, N-ethylmorpholine, N-propylmorpholine, and N-butylmorpholine.

The number of carbon atoms in the alkyl group in the trialkyl amine is preferably 1 or more and 6 or less, more preferably 1 or more and 5 or less, and yet more preferably 1 or more and 4 or less.

Specific examples of the trialkylamine include triethylamine, trimethylamine, N,N-dimethylethylamine, N,N-dimethylpropylamine, N,N-dimethylbutylamine, N,N-diethylmethylamine, N,N-dipropylethylamine, and N,N-dimethylisopropylamine.

The number of carbon atoms in the alcohol contained in the tertiary amino alcohol is preferably 1 or more and 6 or less, more preferably 1 or more and 5 or less, and yet more preferably 1 or more and 4 or less.

When the tertiary amino alcohol has an alkyl group, the number of carbon atoms in the alkyl group is preferably 1 or more and 6 or less, more preferably 1 or more and 5 or less, and yet more preferably 1 or more and 4 or less.

Specific examples of the tertiary amino alcohol include N,N-dimethylethanolamine, N,N-dimethylpropanolamine, N,N-dimethylisopropanolamine, N,N-diethylethanolamine, N-ethyldiethanolamine, N-methyldiethanolamine, triethanolamine, and triisopropanolamine.

The substituent of the N-substituted imidazole may be an alkyl group.

The number of carbon atoms in the alkyl group is preferably 1 or more and 6 or less, more preferably 1 or more and 5 or less, and yet more preferably 1 or more and 4 or less.

Specific examples of the N-substituted imidazole include 1-methylimidazole, 1-ethylimidazole, and 1,2-dimethylimidazole.

The boiling point of the amine compound (A) is preferably 60° C. or higher and 150° C. or lower, more preferably 70° C. or higher and 140° C. or lower, and yet more preferably 80° C. or higher and 130° C. or lower.

When the boiling point of the amine compound (A) is within the aforementioned numerical range, the difference in boiling temperature between the amine compound (A) and the organic solvent (B) becomes appropriate, and, during firing with the imidization in progress, the organic solvent (B) is more likely to remain in the dry film. Thus, the high flowability of the particles in the dry film is likely to be maintained. Thus, a porous polyimide film having a high open pore ratio is easily obtained. Thus, a polyimide precursor solution from which a polyimide film having a low resistance value is obtained is easily obtained.

The amine compound (A) having a boiling point of 60° C. or higher and 150° C. or lower may be at least one selected from the group consisting of N-substituted morpholines, trialkylamines, and tertiary amino alcohols.

When the amine compound (A) having a boiling point of 60° C. or higher and 150° C. or lower is at least one selected from the group consisting of N-substituted morpholines, trialkylamines, and tertiary amino alcohols, a polyimide precursor solution from which a polyimide film having a low resistance value is obtained is easily obtained.

The reason for this is presumably as follows.

When the aforementioned compound is used as the amine compound (A), the imidization is accelerated, and high strength is easily achieved. When the boiling point of the amine compound (A) is 60° C. or higher, the polyimide precursor solution does not easily evaporate during application, and thus the imidization progresses smoothly. When the boiling point of the amine compound (A) is 150° C. or lower, the amine compound (A) is inhibited from remaining in the film during the drying step and onward, and thus, due to a shortened curing reaction time, the fine particles move more easily, and open pores are easily formed. Moreover, amine-derived odor rarely remains in the film.

Specific examples of the N-substituted morpholine having a boiling point of 60° C. or higher and 150° C. or lower include N-methylmorpholine (116° C.), N-ethylmorpholine (139° C.), N-propylmorpholine (156° C.), and N-butylmorpholine (78° C./22 mmHg).

Specific examples of the trialkylamine having a boiling point of 60° C. or higher and 150° C. or lower include triethylamine (90° C.), N,N-dimethylpropylamine (66° C.), N,N-dimethylbutylamine (93° C.), N,N-diethylmethylamine (62° C.), N,N-dipropylethylamine (127° C.), and N,N-dimethylisopropylamine (68° C.).

Examples of the tertiary amino alcohol having a boiling point of 60° C. or higher and 150° C. or lower include N,N-dimethylethanolamine (134° C.) and N,N-dimethylisopropanolamine (125° C.).

From the viewpoint of obtaining a polyimide precursor dry film and a polyimide film having high strength, the amine compound (A) may be an N-substituted morpholine.

These amine compounds (A) may be used alone or in combination.

From viewpoints of increasing the open pore ratio in the porous polyimide film to be obtained and obtaining a polyimide film having a low resistance value, the ratio of the number of moles of the amine compound (A) to the number of moles of the tetracarboxylic dianhydride component in the polyimide precursor is preferably 0.5 or more and 3.0 or less, more preferably 0.6 or more and 2.5 or less, and yet more preferably 0.7 or more and 2.0 or less on a molar basis.

The amine compound (A) content in the polyimide precursor solution of the exemplary embodiment relative to the entire mass of the water-based solvent contained in the polyimide precursor solution is preferably 1 mass % or more and 50 mass % or less, more preferably 2 mass % or more and 30 mass % or less, and yet more preferably 3 mass % or more and 20 mass % or less.

The number of moles of the amine compound (A) is the number of moles of the amine compound (A) contained in the polyimide precursor solution.

The number of moles of the tetracarboxylic dianhydride component in the polyimide precursor is the number of moles of the tetracarboxylic dianhydride used in producing the polyimide precursor.

### Organic Solvent (B)

The organic solvent (B) is an organic solvent other than the amine compound (A) and amide compounds.

The boiling point of the organic solvent (B) is higher than the boiling point of the amine compound (A).

The boiling point of the organic solvent (B) is 200° C. or higher and 300° C. or lower.

Here, the organic solvent (B) may be any organic solvent other than the amine compound (A) and amide compounds as long as the boiling point is higher than the boiling point of the amine compound (A) and is 200° C. or higher and 300° C. or lower and the particles can be dispersed. An appropriate selection may be made from among known organic solvents.

The organic solvent (B) may be, for example, at least one selected from the group consisting of ketone solvents, ester solvents, and hydrocarbon solvents.

The organic solvent (B) is more preferably at least one selected from the group consisting of ketone solvents and ester solvents among the aforementioned solvents.

When the organic solvent (B) is at least one selected from the group consisting of ketone solvents, ester solvents, and hydrocarbon solvents, a polyimide precursor solution from which a polyimide film having a low resistance value is obtained is easily obtained. The reason for this is presumably as follows.

The aforementioned solvents have good affinity with the particles, and when a dry film obtained by applying the polyimide precursor solution and drying the resulting coating film is fired, the dispersibility of the particles in the dry film is easily increased. Thus, a porous polyimide film having a high open pore ratio can be easily obtained. Thus, a polyimide precursor solution from which a polyimide film having a low resistance value is obtained is easily obtained.

The ketone solvent is an organic solvent having a ketone structure.

Examples of the ketone solvent include linear ketones, cyclic ketones, and aromatic ketones.

A cyclic ketone is a ketone in which a carbonyl group is included in one part of the cyclic structure.

An aromatic ketone is a ketone in which a carbonyl group is bonded to an aromatic ring.

The number of carbon atoms in the ketone solvent is, for example, preferably 5 or more and 20 or less, more preferably 7 or more and 18 or less, and yet more preferably 9 or more and 16 or less.

Specific examples of the linear ketone include decanone (200° C. or higher and 215° C. or lower), undecanone (220° C. or higher and 230° C. or lower), dodecanone (240° C. or higher and 250° C. or lower), tridecanone (260° C. or higher and 270° C. or lower), and tetradecanone (270° C. or higher and 280° C. or lower).

Specific examples of the cyclic ketone include isophorone (215° C.), cyclodecanone (106° C. or higher and 107° C. or lower (12 mmHg)), and cycloundecanone (106° C. (4 mmHg)).

Specific examples of the aromatic ketone include acetophenone (202° C.), propiophenone (216° C.), and butyrophenone (221° C.).

The ester solvent is an organic solvent containing an ester group.

Examples of the ester solvent include linear esters, cyclic esters, and aromatic esters.

A linear ester refers to an ester that is linear.

A cyclic ester refers to an ester in which an ester group is included in one part of the cyclic structure.

An aromatic ester is an ester in which an ester group is bonded to an aromatic ring.

The number of carbon atoms in the ester solvent is preferably 5 or more and 20 or less, more preferably 7 or more and 18 or less, and yet more preferably 9 or more and 16 or less.

Specific examples of the linear esters include methyl nonanoate (214° C.), methyl decanoate (229° C.), methyl undecanoate (248° C.), ethyl nonanoate (227° C.), and ethyl decanoate (245° C.).

Specific examples of the cyclic esters include γ-butyrolactone (204° C.), δ-valerolactone (220° C.), δ-valerolactone (253° C.), ethylene carbonate (260° C.), and propylene carbonate (242° C.).

Specific examples of the aromatic esters include methyl benzoate (200° C.), methyl benzoate (212° C.), propyl benzoate (230° C.), and butyl benzoate (250° C.).

Examples of the hydrocarbon solvent include aliphatic hydrocarbon solvents and aromatic hydrocarbon solvents.

The number of carbon atoms in the hydrocarbon solvent is preferably 10 or more and 20 or less, more preferably 11 or more and 18 or less, and yet more preferably 12 or more and 16 or less.

Specific examples of the aliphatic hydrocarbon solvents include dodecane (215° C.), tridecane (234° C.), tetradecane (254° C.), pentadecane (269° C.), and hexadecane (287° C.).

Specific examples of the aromatic hydrocarbon solvent include 1,2,3,4-tetrahydronaphthalene (207° C.), 2,2′-dimethylbiphenyl (259° C.), and 2-ethylnaphthalene (252° C.).

The organic solvent (B) content relative to the amine compound (A) is preferably 1 mass % or more and 30 mass % or less, more preferably 1 mass % or more and 15 mass % or less, yet more preferably 2 mass % or more and 13 mass % or less, and particularly preferably 3 mass % or more and 10 mass % or less.

When the organic solvent (B) content relative to the amine compound (A) is within the aforementioned numerical range, the organic solvent (B) is likely to remain in the dry film during firing of a dry film obtained by applying and drying the polyimide precursor solution so that the dispersibility of the particles in the dry film is increased. During firing, the dispersibility of the particles in the dry film is easily increased. Thus, a porous polyimide film having a high open pore ratio can be easily obtained. Thus, a polyimide precursor solution from which a polyimide film having a low resistance value is obtained is easily obtained.

### Amide Compound

The water-based solvent may contain an amide compound.

An amide compound is a compound having an amide group.

Examples of the amide compound include linear amides, cyclic amides, and aromatic amides.

A cyclic amide is an amide in which an amide group is included in one part of the cyclic structure.

An aromatic amide is an amide in which an amide group is bonded to an aromatic ring.

From the viewpoint of easily obtaining a polyimide precursor solution from which a polyimide film having a low resistance value is obtained, the amide compound may be a cyclic amide.

The number of carbon atoms in the cyclic amide is, for example, preferably 4 or more and 20 or less, more preferably 4 or more and 15 or less, and yet more preferably 5 or more and 10 or less.

### Amide Compound Having a Pyrrolidone Structure

The cyclic amide may be an amide compound having a pyrrolidone structure.

From the viewpoint of easily obtaining a polyimide precursor solution from which a polyimide film having a low resistance value is obtained, the cyclic amide may be an amide compound that has a pyrrolidone structure and has a boiling point of 100° C. or higher and 300° C. or lower.

Hereinafter, an amide compound that has a pyrrolidone structure and a boiling point of 100° C. or higher and 300° C. or lower may also be referred to as a “particular pyrrolidone compound”.

Here, the pyrrolidone structure refers to a structure represented by formula (A) below.

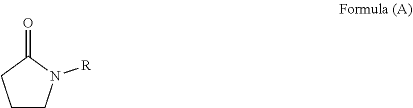

In formula (A), R represents a hydrogen atom or a hydrocarbon group that may have a substituent.

Examples of the hydrocarbon group include an alkyl group, an alkenyl group, an alkynyl group, and an aryl group.

From the viewpoint of easily obtaining a polyimide precursor solution from which a polyimide film having a low resistance value is obtained, the particular pyrrolidone compound may be an amide compound that has a pyrrolidone structure represented by formula (A) with R representing an alkyl group or an alkenyl group.

Furthermore, from the viewpoint of easily obtaining a polyimide precursor solution from which a polyimide film having a low resistance value is obtained, when the particular pyrrolidone compound is an amide compound that has a pyrrolidone structure represented by formula (A) with R representing an alkyl group or an alkenyl group, the number of carbon atoms in the alkyl group and the alkenyl group in the particular pyrrolidone compound is preferably 1 or more and 10 or less, more preferably 1 or more and 5 or less, and yet more preferably 1 or more and 3 or less.

When the particular pyrrolidone compound, which has high affinity with a polyamic acid or a polyimide, and water, is contained, the particular pyrrolidone compound rarely interferes with the particles, and thus the particles move more easily and open pores are more easily formed.

Specific examples of the particular pyrrolidone compounds include N-methyl-2-pyrrolidone (202° C.) and N-vinyl-2-pyrrolidone (193° C. (533 hPa)).

The particular pyrrolidone compound content relative to the polyamic acid is preferably 10 mass % or more and 70 mass % or less, more preferably 20 mass % or more and 60 mass % or less, and yet more preferably 30 mass % or more and 50 mass % or less.

When the particular pyrrolidone compound content relative to the polyamic acid is within the aforementioned numerical range, the particles do not dissolve in the particular pyrrolidone compound and rarely aggregate; thus, a porous polyimide film having a high open pore ratio is more easily obtained. Thus, a polyimide precursor solution from which a polyimide film having a low resistance value is obtained can be more easily obtained.

### Water

The water-based solvent used in this exemplary embodiment contains water.

Examples of the water include distilled water, ion exchange water, ultra-filtrated water, and pure water.

The water content used in this exemplary embodiment relative to the total mass of the water-based solvent contained in the polyimide precursor solution is preferably 50 mass % or more and 99 mass % or less, more preferably 70 mass % or more and 97 mass % or less, and yet more preferably 80 mass % or more and 96 mass % or less.

The water-based solvent content in the polyimide precursor solution of the exemplary embodiment relative to the entire mass of the polyimide precursor solution is preferably 60 mass % or more and 99.9 mass % or less and more preferably 75 mass % or more and 99 mass % or less.

### Other Solvents

The water-based solvent may contain solvents other than the organic solvent (B) and water.

Examples of other solvents include water-soluble organic solvents and aprotic polar solvents. From the viewpoints of the transparency, mechanical strength, etc., of a polyimide molded body, a water-soluble organic solvent may be used as other solvents. In particular, from the viewpoints of not only the transparency and mechanical strength but also improving various other properties of polyimide molded body, such as heat resistance, electrical characteristics, and solvent resistance, the water-based solvent may contain no or little, if any, aprotic polar solvent (for example, the amount is 40 mass % or less and preferably 30 mass % or less relative to the total of the water-based solvent). Here, “water-soluble” means that 1 mass % or more of the subject substance dissolves in water at 25° C.

Examples of the water-soluble organic solvent include a water-soluble ether solvent (in other words, a water-soluble solvent having an ether bond in molecule), a water-soluble ketone solvent (in other words, a water-soluble solvent having a ketone group in one molecule), and a water-soluble alcohol solvent (a water-soluble solvent having an alcoholic hydroxyl group in one molecule).

These other solvents may be used alone or in combination.

A solvent that does not dissolve the particles may be used as other solvents.

The other solvent content relative to the total of the polyimide precursor solution is preferably 10 mass % or less, more preferably 5 mass % or less, and yet more preferably 2 mass % or less.

### Other Components

The polyimide precursor solution of this exemplary embodiment may contain a catalyst for accelerating imidization reaction, a leveling material for improving the film forming quality, etc.

A dehydrating agent such as an acid anhydride or an acid catalyst such as a phenolic derivative, a sulfonic acid derivative, or a benzoic acid derivative may be used as the catalyst for accelerating imidization reaction.

The polyimide precursor solution may contain, depending on the purpose of using the porous polyimide film, a conductive material (specifically, an electrically conductive (for example, a volume resistivity of less than 10⁷ Ω·cm) or semiconductive material (for example, a volume resistivity of 10⁷ Ω·cm or more and 10¹³ Ω·m or less)) as a conductive agent added to impart electrical conductivity, for example.

Examples of the conductive agent include carbon black (for example, acidic carbon black having a pH of 5.0 or less); metals (for example, aluminum and nickel); metal oxides (for example, yttrium oxide and tin oxide); and ion-conductive substances (for example, potassium titanate and LiCl). These conductive agents may be used alone or in combination.

In addition, the polyimide precursor solution may contain, depending on the purpose of the use of the porous polyimide film, inorganic particles added to improve mechanical strength. Examples of the inorganic particles include powder materials such as silica powder, alumina powder, barium sulfate powder, titanium oxide powder, mica, and talc. LiCoO₂, LiMn₂O, etc., that are used in electrodes of lithium ion batteries may also be contained.

### Difference in Boiling Point Between Amine Compound (A) and Organic Solvent (B)

The difference between the boiling point of the amine compound (A) and the boiling point of the organic solvent (B) (boiling point of organic solvent (B)−boiling point of amine compound (A)) is preferably 10° C. or more and 200° C. or less, more preferably 20° C. or more and 180° C. or less, yet more preferably 30° C. or more and 160° C. or less, still more preferably 40° C. or more and 140° C. or less, and most preferably 50° C. or more and 185° C. or less.

When the difference in boiling point between the amine compound (A) and the organic solvent (B) is within the aforementioned range, a polyimide precursor solution from which a polyimide film having a low resistance value is obtained can be more easily obtained. The reason for this is presumably as follows.

When difference in boiling point between the amine compound (A) and the organic solvent (B) is within the aforementioned range, the organic solvent (B) evaporate less from the dry film during firing of the dry film obtained by applying and drying the polyimide precursor solution. Thus, the flowability of the particles in the dry film during firing is more likely to stay high. Thus, a porous polyimide film having a high open pore ratio can be easily obtained. Thus, a polyimide precursor solution from which a polyimide film having a low resistance value is obtained can be more easily obtained.

From the viewpoint of adjusting the difference in boiling point between amine compound (A) and organic solvent (B) to be within the aforementioned range, the combination of the amine compound (A) and the organic solvent (B) may be as follows, for example.
Amine compound (A): N-methylmorpholine, organic solvent (B): γ-butyrolactone
Amine compound (A): N-methylmorpholine, organic solvent (B): ethylene carbonate
Amine compound (A): triethylamine, organic solvent (B): ethylene carbonate
Amine compound (A): 1,2-dimethylimidazole, organic solvent (B): ethylene carbonate
Amine compound (A): N-methylmorpholine, organic solvent (B): acetophenone

### Porous Polyimide Film Production Method

Hereinafter, one example of a method for producing the porous polyimide film according to an exemplary embodiment is described.

A polyimide film production method according to an exemplary embodiment includes a step (P-1) of forming a coating film by applying the polyimide precursor solution of the exemplary embodiment to a substrate; a step (P-2) of forming a dry film by drying the coating film; and a step (P-3) of forming a polyimide film by imidizing the polyimide precursor in the dry film by firing the dry film, the step (P-3) including removing the particles.

In the description of the production method, the same components are denoted by the same reference signs in FIGURE. In FIGURE, 31 denotes a substrate, 51 denotes a release layer, 10A denotes a pore, and 10 denotes a porous polyimide film.

### Method for Producing Polyimide Precursor Solution

The method for producing a polyimide precursor solution according to an exemplary embodiment is not particularly limited, and may be as follows, for example.

One example is a method that involves polymerizing a tetracarboxylic dianhydride and a diamine compound in a solution that contains particles, and a water-based solvent containing an amine compound (A), an organic solvent (B) other than the amine compound (A) and amide compounds, and water so as to generate a polyimide precursor and obtain a polyimide precursor solution.

According to this method that uses a water-based solvent, the productivity is high, the polyimide precursor solution can be produced in one step, and thus the process can be simplified.

Another example is a method that involves polymerizing a tetracarboxylic dianhydride and a diamine compound in an organic solvent such as aprotic polar solvent or an amide compound (for example, N-methyl-2-pyrrolidone (NMP)) to form a polyimide precursor, and then injecting a water-based solvent such as water or alcohol thereto to precipitate the polyimide precursor. Subsequently, the precipitated polyimide precursor is dissolved in a solution that contains particles and a water-based solvent containing an amine compound (A), an organic solvent (B) other than the amine compound (A) and the amide compound, and water so as to obtain a polyimide precursor solution.

### Step (P-1)

The step (P-1) is a step of forming a coating film by applying the polyimide precursor solution to a substrate.

First, the polyimide precursor solution according to the exemplary embodiment is prepared.

Next, the polyimide precursor solution is applied to a substrate to form a coating film.

The substrate on which a coating film containing the polyimide precursor and particles is formed is not particularly limited. Examples of the substrate include resin substrates such as polystyrene and polyethylene terephthalate substrates; glass substrates; ceramic substrates; metal substrates such as iron and stainless steel (SUS) substrates; and hybrid material substrates in which these materials are used in combination. In addition, if needed, a release layer may be formed on the substrate by performing a release treatment by using a silicone or fluorine releasing agent, for example.

The shape of the substrate on which a coating film containing the polyimide precursor and particles is formed is not particularly limited, and may be a plate shape.

The method for applying the polyimide precursor solution to the substrate is not particularly limited. Examples of the method include a spray coating method, a spin coating method, a roll coating method, a bar coating method, a slit die coating method, and an inkjet coating method.

### Step (P-2)

The step (P-2) is a step of forming a dry film by drying the coating film obtained in step (P-1).

Specifically, the coating film obtained in step (P-1) is dried by a method such as heat drying, natural drying, or vacuum drying, so as to form a dry film. More specifically, to form a dry film, drying is performed so that the solvent remaining in the dry film accounts for 50% or less (preferably 30% or less) of the solid component of the dry film.

### Step (P-3)

The step (P-3) is a step of forming a polyimide film by heating the dry film obtained in step (P-2) so as to imidize the polyimide precursor. The step (P-3) also includes a process of removing the particles. A porous polyimide film is obtained through the process of removing the particles.

In the step (P-3), specifically, the dry film obtained in step (P-2) is heated to allow imidization to progress, and then further heated to form a polyimide film in which imidization has progressed. As the imidization progresses and the imidization rate increases, the polyimide precursor becomes increasingly insoluble in the organic solvent.

Furthermore, in the step (P-3), the particles are removed. The particles may be removed during the process of heating the coating film to imidize the polyimide precursor, or may be removed from the polyimide film after completion of the imidization (after imidization).

In this exemplary embodiment, the process of imidizing the polyimide precursor refers to a process of heating the dry film obtained in the step (P-2) to allow imidization to progress before the imidization is completed and the dry film turns into a polyimide film.

From the viewpoint of ease of removing the particles, etc., the process of removing the particles may be performed during the imidization of the polyimide precursor and at a time point where the imidization rate of the polyimide precursor in the polyimide film is 10% or more. At an imidization rate of 10% or more, the form is easy to maintain.

Next, the process of removing the particles is described.

First, a process of removing resin particles is described.

Examples of the process of removing the resin particles include a method that involves removing the resin particles by heating, a method that involves removing the resin particles by dissolving in an organic solvent that dissolves the resin particles, and a method involving removing the resin particles by decomposition using a laser or the like. Among these, a method that involves removing the resin particles by heating or a method that involves removing the resin particles by dissolving in an organic solvent that dissolves the resin particles may be employed.

The method that involves removing the particles by heating may involve, for example, decomposing the resin particles by the heat applied to allow imidization to progress during the process of imidizing the polyimide precursor. In this manner, there is no operation for removing the resin particles by using a solvent, and the number of steps can be reduced.

One example of the method for removing the resin particles by using an organic solvent that dissolves the resin particles is a method that involves bringing the resin particles into contact with an organic solvent that dissolves the resin particles (for example, immersing the resin particles in a solvent) to dissolve and remove the resin particles. When the resin particles in this state are immersed in the solvent, the resin particle dissolving efficiency is high.

The organic solvent used for removing the resin particles may be any organic solvent that does not dissolve a polyimide film before and after completion of the imidization but can dissolve the resin particles. Examples of the organic solvent include ethers such as tetrahydrofuran (THF), aromatics such as toluene; ketones such as acetone; and esters such as ethyl acetate.

When the resin particles are removed by dissolving to form a porous film, a common solvent such as tetrahydrofuran, acetone, toluene, or ethyl acetate may be used. Depending on the resin particles and the polyimide precursor used, water can also be used.

Furthermore, when the resin particles are removed by heating to form a porous film, the resin particles do not decompose at the drying temperature after the application, and thus are pyrolized at a temperature used to imidize the polyimide precursor coating film. From such a viewpoint, the pyrolysis onset temperature of the resin particles is preferably 150° C. or higher and 320° C. or lower, more preferably 180° C. or higher and 300° C. or lower, and yet more preferably 200° C. or higher and 280° C. or lower.

A process of removing inorganic particles when the polyimide precursor solution contains inorganic particles will now be described.

An example of the process of removing inorganic particles is a method that involves removing inorganic particles by using a liquid (hereinafter may also be referred to as a “particle removing liquid”) that dissolves the inorganic particles but not the polyimide precursor or the polyimide. The particle removing liquid is selected according to the inorganic particles used. Examples thereof include aqueous solutions of acids, such as hydrofluoric acid, hydrochloric acid, hydrobromic acid, boric acid, perchloric acid, phosphoric acid, sulfuric acid, nitric acid, acetic acid, trifluoroacetic acid, and citric acid; and aqueous solutions of bases such as sodium hydroxide, potassium hydroxide, tetramethylammonium hydroxide, sodium carbonate, potassium carbonate, ammonia, and the aforementioned organic amines. Depending on the inorganic particles and polyimide precursor used, water alone can also be used.

In the step (P-3), any heating method may be employed to heat the dry film obtained in the step (P-2) to allow imidization to progress and to obtain a polyimide film. For example, the dry film may be heated in two stages. When two-stage heating is performed, following heating conditions may be employed, for example.

For the heating conditions of the first stage, the temperature may be at a level in which the shape of the particles is retained. Specifically, the temperature may be within the range of 50° C. or higher and 150° C. or lower, or in the range of 60° C. or higher and 140° C. or lower. The heating time may be within the range of 10 minutes or longer and 60 minutes or shorter. The higher the heating temperature, the shorter the heating time.

For the heating conditions of the second stage, heating may be performed in the range of, for example, 150° C. or higher and 450° C. or lower (preferably 200° C. or higher and 430° C. or lower) for 20 minutes or longer and 120 minutes or shorter. Under such heating condition ranges, the imidization reaction progresses further, and a polyimide film can be formed. In performing the thermal reaction, the temperature may be increased stepwise or gradually at a constant rate before reaching the final heating temperature.

Note that the heating conditions are not limited to the two-stage heating method, and, for example, a one-stage heating method may be employed instead. When a one-stage heating method is employed, for example, imidization may be completed under the heating conditions of the second stage described above.

In the step (P-3), in order to increase the opening ratio, the process of exposing the particles may be performed to have the particles exposed. In the step (P-3), the process of exposing the particles may be performed during or after the imidizing of the polyimide precursor and before the process of removing the particles.

In this case, for example, when a particle-dispersed polyimide precursor solution is used to form a coating film on a substrate, the particle-dispersed polyimide precursor solution is applied to the substrate to form a coating film embedding the particles. Next, the coating film is dried to form a coating film that contains a polyimide precursor and the particles. The coating film formed by this method is in a state in which the particles are embedded. Before this coating film is heated and subjected to the particle removing process, a process of imidizing the polyimide precursor or the process of exposing the particles from the polyimide film after the completion of the imidization (after imidization) may be performed.

In the step (P-3), the process of exposing the particles may be performed, for example, when the polyimide film is in the following state.

When the process of exposing the particles is performed at a polyimide precursor imidization rate of less than 10% (that is, when the polyimide precursor is in a soluble state in the solvent) in the polyimide film, examples of the process of exposing the particles embedded in the polyimide film include a wiping process and a solvent immersion process. The solvent used here may be the same as or different from the solvent used in the particle-dispersed polyimide precursor solution of the exemplary embodiment.

When the process of exposing the particles is performed under the condition that the imidization rate of the polyimide precursor in the polyimide film is 10% or more (in other words, when the polyimide precursor is hardly soluble in the water or organic solvent) and that the imidization is completed in the polyimide film, examples of the method include a method that exposes the particles by mechanical machining using a tool such as sandpaper, and, if the particles are resin particles, a method that involves exposing the resin particles by decomposition by using a laser or the like.

For example, when mechanical machining is employed, parts of particles that are present in the upper parts of the particles embedded in the polyimide film (in other words, the region remote from the substrate) are machined along with the polyimide film on the particles, and the machined particles are exposed in the surface of the polyimide film.

Subsequently, the aforementioned process of removing the particles is performed on the polyimide film with exposed particles so as to remove these particles. As a result, a porous polyimide film from which the particles have been removed is obtained (refer to FIGURE).

In the description above, the method for producing a porous polyimide film subjected to the particle exposing process in the step (P-3) is described; alternatively, from the viewpoint of increasing the opening ratio, the particle exposing process may be performed in the step (P-2). In this case, in the step (P-2), the particle exposing process may be performed during drying and forming of the coating film to create a state in which the particles are exposed. The opening ratio of the porous polyimide film can be increased by performing this particle exposing process.

For example, after obtaining a coating film that contains the polyimide precursor solution and the particles, during the process of drying the coating film to form a coating film that contains a polyimide precursor and the particles, the coating film is in such a state that the polyimide precursor is soluble in the solvent. When the coating film is in this state, the particles can be exposed by performing the wiping process, the solvent immersing process, or the like. Specifically, a process of exposing the particle layer by wiping the polyimide precursor solution that is present in the region above the particle layer is performed to remove the polyimide precursor solution that has been present in the region above the particle layer. As a result, the particles that have been present in the upper region of the particle layer (in other words, the region of the particle layer remote from the substrate) are exposed in the surface of the coating film.

In the step (P-3), the substrate used in the step (P-1) to form the aforementioned coating film may be separated when the film is dried, when the polyimide precursor in the polyimide film has become sparingly soluble in the organic solvent, or when a completely imidized film is obtained.

A porous polyimide film is obtained through the aforementioned steps. The porous polyimide film may be post-processed.

The imidization rate of the polyimide precursor will now be described.

Examples of the partly imidized polyimide precursor include precursors that have structures having repeating units represented by general formula (V-1), general formula (V-2), and general formula (V-3) below.

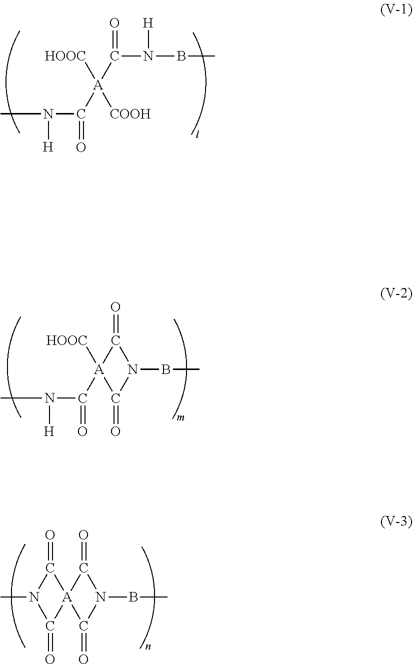

In general formula (V-1), general formula (V-2), and general formula (V-3), A and B are the same as A and B in formula (I). In the formulae, 1 represents an integer of 1 or more, and m and n each independently represent 0 or an integer of 1 or more.

The imidization rate of the polyimide precursor indicates the ratio of the number of bonding sites (2n+m) where imide ring closure has occurred relative to the number of all bonding sites (2l+2m+2n) (the sites where the tetracarboxylic dianhydride and the diamine compound react with each other) of the polyimide precursor. In other words, the imidization rate of the polyimide precursor is expressed by “(2n+m)/(2l+2m+2n)”.

The imidization rate, “(2n+m)/(2l+2m+2n)”, of the polyimide precursor is measured by the following method.

### Measurement of Imidization Rate of Polyimide Precursor Preparation of Polyimide Precursor Sample

(i) A polyimide precursor composition to be measured is applied to a silicone wafer such that the film thickness is in the range of 1 μm or more and 10 μm or less to prepare a coating film sample.

(ii) The coating film sample is immersed in tetrahydrofuran (THF) for 20 minutes to substitute the solvent in the coating film sample with tetrahydrofuran (THF). The solvent used in immersion is not limited to THF, and may be selected from solvents that are miscible with the solvent component contained in the polyimide precursor composition and that do not dissolve the polyimide precursor. Specifically, alcohol solvents such as methanol and ethanol, and ether compounds such as dioxane can be used.

(iii) The coating film sample is taken out from the THF, and the THF adhering the surface of the coating film sample is removed by spraying N₂ gas. At a reduced pressure of 10 mmHg or less and in the range of 5° C. or higher and 25° C. or lower, the coating film sample is treated for 12 hours or longer to dry and prepare a polyimide precursor sample.

### Preparation of 100% Imidized Standard Sample

(iv) A coating film sample is prepared as in (i) above by applying the polyimide precursor composition to be measured to a silicone wafer.

(v) The coating film sample is heated at 380° C. for 60 minutes to perform imidization reaction and prepare a 100% imidized standard sample.

### Measurement and Analysis

(vi) Infrared absorption spectra of the 100% imidized standard sample and the polyimide precursor sample are measured by using a Fourier transform infrared spectrometer (FT-730 produced by HORIBA, Ltd.). From the 100% imidized standard sample, a ratio I′(100) of the imide bond-derived absorption peak (Ab′(1780 cm⁻¹)) around 1780 cm⁻¹ to the aromatic ring-derived absorption peak (Ab′(1500 cm⁻¹)) around 1500 cm⁻¹ is determined.

(vii) In the same manner, the polyimide precursor sample is measured, and a ratio I(x) of the imide bond-derived absorption peak (Ab(1780 cm⁻¹)) around 1780 cm⁻¹ to the aromatic ring-derived absorption peak (Ab(1500 cm⁻¹)) around 1500 cm⁻¹ is determined.

Then the imidization rate of the polyimide precursor is calculated from the following formula using the measured absorption peak ratios I′(100) and I(x).

imidization rate of polyimide precursor=I(x)/I′(100) Formula:

I′(100)=(Ab′(1780 cm⁻¹))/(Ab′(1500 cm⁻¹)) Formula:

I(x)=(Ab(1780 cm⁻¹))/(Ab(1500 cm⁻¹)) Formula:

The measurement of the imidization rate of the polyimide precursor is applied to the measurement of the imidization rate of an aromatic polyimide precursor. When measuring the imidization rate of an aliphatic polyimide precursor, a peak derived from a structure that remains unchanged between before and after imidization reaction is used as the internal standard peak instead of the aromatic ring absorption peak.

### Porous Polyimide Film

Hereinafter, a porous polyimide film of an exemplary embodiment is described.

The porous polyimide film may be produced by the porous polyimide film production method (that is, a porous polyimide film production method that has the step (P-1), the step (P-2), and the step (P-3)) of the exemplary embodiment.

The particles in the dry film in the step (P-3) can easily maintain high flowability when the film is produced by the porous polyimide film production method of the exemplary embodiment. Thus, a porous polyimide film obtained tends to have an increased open pore ratio. Thus, a polyimide film having a low resistance value can be easily obtained.

### Properties of Porous Polyimide Film

### Porosity

From the viewpoint of maintaining sufficient film strength, the porous polyimide film of the exemplary embodiment may have a porosity of 50% or more and 80% or less. The lower limit of the porosity is more preferably 55% or more and yet more preferably 60% or more. The upper limit of the porosity is more preferably 75% or less and yet more preferably 70% or less.

For example, when the porous polyimide film of the exemplary embodiment is applied to a battery separator, the porosity may be within the aforementioned range in view of excellent cycle characteristics.

The porosity of the porous polyimide film of the exemplary embodiment is a value determined from the apparent density and true density of the porous polyimide film. The apparent density is a value obtained by dividing the mass (g) of the porous polyimide film by the volume (cm³) of the entire porous polyimide film including the pores. The true density is a value obtained by dividing the mass (g) of the porous polyimide film by the volume (cm³) of the porous polyimide film excluding the pores. The porosity of the porous polyimide film is calculated from the following formula:

porosity (%)={1−(d/ρ)}×100=[1−{(w/t)/ρ)}]×100 Formula:

d: apparent density (g/cm³) of porous polyimide film

ρ: true density (g/cm³) of porous polyimide film

w: weight of porous polyimide film per unit area (g/m²)

t: thickness (μm) of porous polyimide film

### Pores

The pores may have a spherical shape or a shape close to spherical. In addition, the pores may be connected and continuous with each other. The pore diameter of the portion where the pores are connected to each other is, for example, preferably 1/100 or more and ½ or less of the maximum diameter of the pores, more preferably 1/50 or more and ⅓ or less of the maximum diameter of the pores, and yet more preferably 1/20 or more and ¼ or less of the maximum diameter of the pores. Specifically, the average pore diameter at the portions where the pores are connected to each other may be 5 nm or more and 1500 nm or less.

The average pore diameter is not particularly limited and is preferably in the range of 10 nm or more and 2500 nm or less, more preferably 50 nm or more and 2000 nm or less, yet more preferably 100 nm or more and 1500 nm or less, and particularly preferably 150 nm or more and 1000 nm or less.

The ratio of the maximum diameter of the pores to the minimum diameter of the pores in the porous polyimide film of the exemplary embodiment (maximum-to-minimum pore diameter ratio) is preferably 1 or more and 2 or less, more preferably 1 or more and 1.9 or less, and yet more preferably 1 or more and 1.8 or less. Within in these ranges, the ratio is further preferably close to 1. When the ratio is within this range, the variation of the pore diameter is suppressed. When the porous polyimide film of the exemplary embodiment is applied to a battery separator of a lithium ion battery, ion flow disturbance is suppressed and thus formation of lithium dendrites is easily suppressed. The “ratio of the maximum diameter of the pores to the minimum diameter of the pores” is the ratio obtained by dividing the maximum diameter of the pores by the minimum diameter of the pores (in other words, the maximum value/minimum value of the pore diameter).

The average pore diameter and the average pore diameter of the portions where the pores are connected to each other are the values obtained by scanning electron microscope (SEM) observation and calculation. Specifically, first, a porous polyimide film is cut to prepare a measurement sample. The measurement sample is observed and calculated by image processing software which is a standard software of VE SEM produced by KEYENCE CORPORATION. The observation and calculation are performed on one hundred pore portions in a measurement sample cross section, and the average value, the minimum diameter, the maximum diameter, and the arithmetic mean diameter are determined. When the shape of the pores is not round, the longest portion is assumed to be the diameter.

### Film Thickness

The film thickness of the porous polyimide film of the exemplary embodiment is not particularly limited and is selected according to the usage. For example, the film thickness may be 10 μm or more and 1000 μm or less. The film thickness is preferably 20 μm or more and more preferably 30 μm or more, and is preferably 500 μm or less and more preferably 400 μm or less.

### Air Permeation Rate

From the viewpoint of substance permeability, the porous polyimide film of the exemplary embodiment preferably has an air permeation rate of 40 seconds or less, more preferably 35 seconds or less, and yet more preferably 20 seconds or less. The lower limit may be 5 seconds or more.

When the air permeation rate of the porous polyimide film is within the aforementioned range, the polyimide film tends to have a high open pore ratio. Thus, the polyimide film tends to have a low resistance.

For example, when the porous polyimide film of the exemplary embodiment is applied to a battery separator, degradation of the cycle characteristics is suppressed by adjusting the air permeation rate to be within the aforementioned range. Since the cycle characteristics improve as the air permeation rate decreases, the air permeation rate may be a value close to zero.

The method for measuring the air permeation rate of the porous polyimide film of this exemplary embodiment is described in Examples below.

### Usage of Porous Polyimide Film

Examples of the usage of the porous polyimide film of the exemplary embodiment include battery separators for lithium batteries etc., separators for electrolytic capacitors, electrolyte membranes of fuel cells etc., battery electrode materials, separation film for gas or liquid, and low-dielectric-constant materials.

When the porous polyimide film of the exemplary embodiment is applied to a battery separator, for example, it is considered that variation of lithium ion flow distribution is suppressed, and thus formation of lithium dendrites is suppressed. This is presumably because variation of pore shapes and pore diameters in the porous polyimide film of the exemplary embodiment are suppressed.

When the porous polyimide film is used as a battery electrode material, the chances of coming into contact with the electrolyte are increased, and thus the capacity of the battery is expected to increase. This is presumably because an electrode material such as carbon black contained in the porous polyimide film becomes exposed on the surfaces of the pores of the porous polyimide film and the surfaces of the porous polyimide film in increased amounts.

Furthermore, for example, pores of the porous polyimide film may be filled with an ionic gel prepared by gelling an ionic liquid, so that the porous polyimide film can be used as an electrolyte membrane. It is considered that since the production method of the exemplary embodiment simplifies the processes, an electrolyte membrane is obtained at low cost.

### EXAMPLES

Examples will now be described, but these examples do not limit the scope of the present disclosure. In the description below, “parts” and “%” are on a mass basis unless otherwise noted.

### Preparation of Resin Particle Dispersion

Mixed are 770 parts by mass of styrene, 230 parts by mass of butyl acrylate, 15.7 parts by mass of dodecanethiol, 19.8 parts by mass of a surfactant, Dowfax 2A1 (47% solution, produced by The Dow Chemical Company), and 576 parts by mass of ion exchange water, and the resulting mixture is stirred and emulsified with a dissolver at a rate of 1,500 rotations per minute for 30 minutes so as to prepare a monomer emulsion. Next, 1.49 parts by mass of Dowfax 2A1 (47% solution, produced by The Dow Chemical Company) and 1270 parts by mass of ion exchange water are injected into a reactor. Under nitrogen stream, the mixture is heated to 75° C., 75 parts by mass of the monomer emulsion is then added thereto, and a polymerization initiator solution prepared by dissolving 15 parts by mass of ammonium persulfate in 98 parts by mass of ion exchange water is added thereto dropwise over a period of 10 minutes. After dropwise addition, the reaction is conducted for 50 minutes, the remaining monomer emulsion is then added thereto dropwise over a period of 220 minutes, and then the reaction is continued for another 180 minutes. After cooling, the solid concentration is adjusted to 20 mass % to prepare a styrene.acrylic resin particle dispersion as the resin particle dispersion. The resin particles have an average particle diameter of 0.3 μm.

### Example 1

### Preparation of Polyimide Precursor Solution (1)

Under a nitrogen stream, 780 parts of ion exchange water is heated to 50° C., and, under stirring, 18.81 parts of p-phenylenediamine (hereinafter may also be referred to as “PDA”), 51.19 parts of 3,3′,4,4′-biphenyltetracarboxylic dianhydride (hereinafter may also be referred to as “BPDA”), 5.2 parts (20 mass % relative to the amine compound (A)) of γ-butyrolactone serving as the organic solvent (B), and 350 parts of the resin particle dispersion are added. Next, a mixture of 26.40 parts of N-methylmorpholine (hereinafter may also be referred to as “MMO”) serving as the amine compound (A) and 98.52 parts of ion exchange water is added thereto under a nitrogen stream under stirring at 50° C. over a period of 120 minutes. After retaining 50° C. for 15 hours, a polyimide precursor solution having a solid component concentration of 12.7% is obtained.

### Preparation of Porous Polyimide Film

### Porous Polyimide Film

The polyimide precursor solution is applied to a glass substrate (or a substrate) such that the film thickness after drying is about 30 μm and dried at 90° C. for 1 hour, the temperature is then elevated from 90° C. to 380° C. at a rate of 10° C./minute, the temperature of 380° C. is retained for 1 hour, and then the resulting mixture is cooled to room temperature (25° C., the same applies hereinafter) to obtain a porous polyimide film.

### Examples 2 to 29 and Comparative Examples 1 to 5

Polyimide precursor solutions and porous polyimide films are obtained as in Example 1 except that the amine compound (A), the type of the organic solvent (B), the amine compound (A) and organic solvent (B) contents, and the particle content are changed as indicated in Table 1.

The particle content is adjusted by changing the amount of the resin particle dispersion added.

### Examples 30 to 33

Polyimide Precursor Solutions and Porous Polyimide films are obtained as in example 1 except that, in “Preparation of polyimide precursor solution (1)” in Example 1, a particular pyrrolidone compound described in Table 1 is added together with the PDA, BPDA, γ-butyrolactone, and the resin particle dispersion, that the amounts of MMO, γ-butyrolactone, and water are changed so that the MMO, γ-butyrolactone, and water contents are as indicated in Table 1, and that the amount of the resin particle dispersion added is changed so that the particle content is as indicated in Table 1.

The amount of the particular pyrrolidone compound added relative to the polyamic acid is adjusted such that the particular pyrrolidone content is as indicated in Table 1.

### Evaluation

The porous polyimide films obtained in the examples were evaluated in terms of film thickness, porosity, air permeation rate, and cycle characteristics.

### Air Permeation Rate

A prepared porous polyimide film is cut into a 1 cm square to prepare an air permeation rate measurement sample. The sample is interposed and set between a funnel and a base portion of a reduced pressure filtration filter holder (KGS-04 produced by ADVANTEC). The filter holder holding the sample is held upside down and immersed in water, and the funnel is filled with water up to a predetermined position. An air pressure of 0.5 atmosphere (0.05 MPas) is loaded from a portion of the base portion where the base portion is not in contact with the funnel, and the time (seconds) taken for 50 ml of air to pass through is measured and evaluated as the air permeation rate.

The smaller the value of the air permeation rate, the higher the open pore ratio of the porous polyimide film. In other words, the smaller the value of the air permeation rate, the lower the resistance value of the porous polyimide film.

### Cycle Characteristics

A lithium ion battery is prepared by using the porous polyimide film obtained in each example, and the rate of decrease in battery capacity when the battery is repeatedly charged and discharged (1 C charging and 1 C discharging at 25° C.) 500 times is investigated. The smaller the rate of decrease, the better the cycle characteristics, and the evaluation is carried out according to the following standard. The results are indicated in Table 1.

Good: The rate of decrease is less than 15%.

Poor: The rate of decrease is 15% or more.

Abbreviations in Table 1 are as follows.

“Content (relative to water-based solvent, mass %)”: the amine compound (A), organic solvent (B), or water content relative to the total mass of the water-based solvent contained in the polyimide precursor solution.

“(B)/(A)×100%”: The organic solvent (B) content (unit: mass %) relative to the amine compound (A).

“Particle content”: The particle content (unit: vol %) relative to the solid content of the polyimide precursor solution.

“Content (relative to polyamic acid) mass %” of the particular pyrrolidone compound: the particular pyrrolidone compound content (mass %) relative to polyamic acid.

TABLE 1

| | Composition | | | | | | | | | | | | | | | | | |
|---|---|---|---|---|---|---|---|---|---|---|---|---|---|---|---|---|---|---|
| | | | | | | | | | | | Particular | | | | | | | |
| | | | | | | | | | | | pyrrolidone | | | | | | | |
| | Amine compound (A) | | | | Organic solvent (B) | | | | | | compound | | Water | | | | | |
| | | | | Content | | | | Content | Differ- | | | Content | Content | | | | | |
| | | | | (relative | | | | (relative | ence | | | (relative | (relative | | Evaluation | | | |
| | | | | to | | | | to | in | | | to | to | | | | Air | |
| | | | Boil- | water- | | | Boil- | water- | boiling | | | poly- | water- | | Film | | perme- | Cycle |
| | | | ing | based | | | ing | based | point | (B)/(A) × | | amic | based | Particle | thick- | Poros- | ation | charac- |
| | | | point | solvent, | | Cate- | point | solvent, | (° C.) | 100% | | acid) | solvent, | content | ness | ity | rate | teristics |
| | Name | Category | (° C.) | mass %) | Name | gory | (° C.) | mass %) | (B) − (A) | Mass % | Name | mass % | mass %) | Vol % | μm | % | Seconds | — |
| Example 1 | N-Methylmorpholine | N-Substituted | 116 | 6.4 | γ- | Ester | 204 | 1.3 | 88 | 20 | — | — | 92 | 60 | 15 | 60 | 35 | Good |
| | | morpholine | | | Butyrolactone | solvent | | | | | | | | | | | | |
| Example 2 | N-methylmorpholine | N-Substituted | 116 | 6.4 | Ethylene | Ester | 260 | 1.3 | 144 | 20 | — | — | 92 | 60 | 15 | 59 | 25 | Good |
| | | morpholine | | | carbonate | solvent | | | | | | | | | | | | |
| Example 3 | Triethylamine | Trialkylamine | 89 | 6.4 | Ethylene | Ester | 260 | 1.3 | 171 | 20 | — | — | 92 | 60 | 15 | 64 | 15 | Good |
| | | | | | carbonate | solvent | | | | | | | | | | | | |
| Example 4 | 1,2- | N-Substituted | 204 | 6.4 | Ethylene | Ester | 260 | 1.3 | 56 | 20 | — | — | 92 | 60 | 15 | 61 | 50 | Good |
| | Dimethylimidazole | imidazole | | | carbonate | solvent | | | | | | | | | | | | |
| Example 5 | N-Methylmorpholine | N-Substituted | 116 | 6.4 | Acetophenone | Ketone | 202 | 1.3 | 86 | 20 | — | — | 92 | 60 | 15 | 60 | 38 | Good |
| | | morpholine | | | | solvent | | | | | | | | | | | | |
| Comparative | N-Methylmorpholine | N-Substituted | 116 | 6.4 | — | — | — | 0 | — | 0 | — | — | 93.3 | 60 | 15 | 63 | 100 | Poor |
| Example 1 | | morpholine | | | | | | | | | | | | | | | | |
| Comparative | 1,2-Dimethylimidazole | N-Substituted | 204 | 6.4 | γ- | Ester | 204 | 1.3 | 0 | 20 | — | — | 92 | 60 | 15 | 65 | 80 | Poor |
| Example 2 | | imidazole | | | Butyrolactone | solvent | | | | | | | | | | | | |
| Comparative | 1,3-Dimethyl-2- | Other | 225 | 6.4 | γ- | Ester | 204 | 1.3 | −21 | 20 | — | — | 92 | 60 | 15 | 58 | 110 | Poor |
| Example 3 | imidazolidinone | | | | Butyrolactone | solvent | | | | | | | | | | | | |
| Comparative | N-Methylmorpholine | N-Substituted | 116 | 6.4 | Heptyl acetate | Ester | 192 | 1.3 | 76 | 20 | — | — | 92 | 60 | 15 | 59 | 65 | Poor |
| Example 4 | | morpholine | | | | solvent | | | | | | | | | | | | |
| Example 6 | N-Methylmorpholine | N-Substituted | 116 | 6.4 | Amyl | Ester | 299 | 1.3 | 183 | 20 | — | — | 92 | 60 | 15 | 60 | 10 | Good |
| | | morpholine | | | cinnamate | solvent | | | | | | | | | | | | |
| Comparative | N-Methylmorpholine | N-Substituted | 116 | 6.4 | Tributyrin | Ester | 305 | 1.3 | 189 | 20 | — | — | 92 | 60 | 15 | 59 | 60 | Poor |
| Example 5 | | morpholine | | | | solvent | | | | | | | | | | | | |
| Example 7 | 1,2- | N-Substituted | 204 | 6.4 | γ- | Ester | 207 | 1.3 | 3 | 20 | — | — | 92 | 60 | 15 | 60 | 50 | Good |
| | Dimethylimidazole | imidazole | | | Valerolactone | solvent | | | | | | | | | | | | |
| Example 8 | 1.3- | N-Substituted | 204 | 6.4 | γ- | Ester | 219 | 1.3 | 15 | 20 | — | — | 92 | 60 | 15 | 60 | 50 | Good |
| | Dimethylimidazole | imidazole | | | Hexanolactone | solvent | | | | | | | | | | | | |
| Example 9 | N-Methylmorpholine | N-Substituted | 116 | 6.4 | γ- | Ester | 281 | 1.3 | 165 | 20 | — | — | 92 | 60 | 15 | 60 | 15 | Good |
| | | morpholine | | | Decanolactone | solvent | | | | | | | | | | | | |
| Example 10 | Triethylamine | Trialkylamine | 89 | 6.4 | Amyl | Ester | 299 | 1.3 | 210 | 20 | — | — | 92 | 60 | 15 | 60 | 45 | Good |
| | | | | | cinnamate | solvent | | | | | | | | | | | | |
| Example 11 | Tributylamine | Trialkylamine | 216 | 6.4 | Ethylene | Ester | 260 | 1.3 | 44 | 20 | — | — | 92 | 60 | 15 | 60 | 55 | Good |
| | | | | | carbonate | solvent | | | | | | | | | | | | |
| Example 12 | N,N-Dimethylhexane-1- | Trialkylamine | 150 | 6.4 | γ- | Ester | 204 | 1.3 | 54 | 20 | — | — | 92 | 60 | 15 | 60 | 45 | Good |
| | amine | | | | Butyrolactone | solvent | | | | | | | | | | | | |
| Example 13 | N-Methylmorpholine | N-Substituted | 116 | 6.4 | Amyl | Ester | 299 | 1.3 | 183 | 20 | — | — | 92 | 60 | 15 | 60 | 10 | Good |
| | | morpholine | | | cinnamate | solvent | | | | | | | | | | | | |
| Example 14 | N-Methyldiallyiamine | Trialkylamine | 111 | 7.4 | Amyl | Ester | 299 | 1.3 | 188 | 20 | — | — | 92 | 60 | 15 | 60 | 25 | Good |
| | | | | | cinnamate | solvent | | | | | | | | | | | | |
| Example 15 | N-Methylmorpholine | N-Substituted | 116 | 6.4 | Naphthalene | Hydro- | 218 | 1.3 | 102 | 20 | — | — | 92 | 60 | 15 | 58 | 50 | Good |
| | | morpholine | | | | carbon | | | | | | | | | | | | |
| | | | | | | solvent | | | | | | | | | | | | |
| Example 16 | N,N-Dimethylethylamine | Trialkylamine | 38 | 6.4 | γ- | Ester | 204 | 1.3 | 166 | 20 | — | — | 92 | 60 | 15 | 59 | 45 | Good |
| | | | | | Butyrolactone | solvent | | | | | | | | | | | | |
| Example 17 | N,N-Diethylmethylamine | Trialkylamine | 63 | 6.4 | γ- | Ester | 204 | 1.3 | 37 | 20 | — | — | 92 | 60 | 15 | 60 | 50 | Good |
| | | | | | Butyrolactone | solvent | | | | | | | | | | | | |
| Example 18 | N,N-Dimethylhexane-1- | Trialkylamine | 150 | 6.4 | γ- | Ester | 204 | 1.3 | 54 | 20 | — | — | 92 | 60 | 15 | 60 | 45 | Good |
| | amine | | | | Butyrolactone | solvent | | | | | | | | | | | | |
| Example 19 | Tripropylamine | Trialkylamine | 155 | 7.4 | γ- | Ester | 204 | 1.3 | 49 | 20 | — | — | 92 | 60 | 15 | 60 | 40 | Good |
| | | | | | Butyrolactone | solvent | | | | | | | | | | | | |
| Example 20 | 2-(Dimethylamino)ethanol | Tertiary | 135 | 6.4 | γ- | Ester | 204 | 1.3 | 69 | 20 | — | — | 92 | 60 | 15 | 60 | 49 | Good |
| | | aminoalcohol | | | Butylrolactone | solvent | | | | | | | | | | | | |
| Example 21 | N,N,N′,N′- | Trialkylamine | 122 | 7.4 | γ- | Ester | 204 | 1.3 | 82 | 20 | — | — | 92 | 60 | 15 | 59 | 50 | Good |
| | Tetromethylethylenediamine | | | | Butyrolactone | solvent | | | | | | | | | | | | |
| Example 22 | N-Methylmorpholine | N-Substituted | 116 | 6.4 | γ- | Ester | 204 | 1.3 | 88 | 20 | — | — | 92 | 25 | 15 | 25 | 40 | Good |
| | | morpholine | | | Butyrolactone | solvent | | | | | | | | | | | | |
| Example 23 | N-Methylmorpholine | N-Substituted | 116 | 6.4 | γ- | Ester | 204 | 1.3 | 88 | 20 | — | — | 92 | 30 | 15 | 30 | 50 | Good |
| | | morpholine | | | Butyrolactone | solvent | | | | | | | | | | | | |
| Example 24 | N-Methylmorpholine | N- | 116 | 6.4 | γ- | Ester | 204 | 1.3 | 88 | 20 | — | — | 92 | 80 | 15 | 80 | 5 | Good |
| | | Substituted | | | Butyrolactone | solvent | | | | | | | | | | | | |
| | | morpholine | | | | | | | | | | | | | | | | |
| Example 25 | N-Methylmorpholine | N- | 116 | 6.4 | γ- | Ester | 204 | 1.3 | 88 | 20 | — | — | 92 | 85 | 15 | 85 | 50 | Good |
| | | Substituted | | | Butyrolactone | solvent | | | | | | | | | | | | |
| | | morpholine | | | | | | | | | | | | | | | | |
| Example 26 | N-Methylmorpholine | N- | 116 | 6.4 | γ- | Ester | 204 | 0.03 | 88 | 0.5 | — | — | 93 | 60 | 15 | 60 | 40 | Good |
| | | Substituted | | | Butyrolactone | solvent | | | | | | | | | | | | |
| | | morpholine | | | | | | | | | | | | | | | | |
| Example 27 | N-Methylmorpholine | N- | 116 | 6.4 | γ- | Ester | 204 | 0.05 | 88 | 2 | — | — | 93 | 60 | 15 | 60 | 50 | Good |
| | | Substituted | | | Butyrolactone | solvent | | | | | | | | | | | | |
| | | morpholine | | | | | | | | | | | | | | | | |
| Example 28 | N-Methylmorpholine | N- | 116 | 6.4 | γ- | Ester | 204 | 2 | 88 | 30 | — | — | 90 | 60 | 15 | 60 | 21 | Good |
| | | Substituted | | | Butyrolactone | solvent | | | | | | | | | | | | |
| | | morpholine | | | | | | | | | | | | | | | | |
| Example 29 | N-Methylmorpholine | N- | 116 | 6.4 | γ- | Ester | 204 | 2.3 | 88 | 35 | — | — | 90 | 60 | 15 | 60 | 20 | Good |
| | | Substituted | | | Butyrolactone | solvent | | | | | | | | | | | | |
| | | morpholine | | | | | | | | | | | | | | | | |
| Example 30 | N-Methylmorpholine | N- | 116 | 6.4 | γ- | Ester | 204 | 1.3 | 88 | 20 | N- | 10 | 92 | 60 | 15 | 60 | 20 | Good |
| | | Substituted | | | Butyrolactone | solvent | | | | | Methyl- | | | | | | | |
| | | morpholine | | | | | | | | | pyrroli- | | | | | | | |
| | | | | | | | | | | | done | | | | | | | |
| Example 31 | N-Methylmorpholine | N- | 116 | 6.4 | γ- | Ester | 204 | 1.3 | 88 | 20 | N- | 50 | 92 | 60 | 15 | 60 | 5 | Good |
| | | Substituted | | | Butyrolactone | solvent | | | | | Methyl- | | | | | | | |
| | | morpholine | | | | | | | | | pyrroli- | | | | | | | |
| | | | | | | | | | | | done | | | | | | | |
| Example 32 | N-Methylmorpholine | N- | 116 | 6.4 | γ- | Ester | 204 | 1.3 | 88 | 20 | N- | 70 | 92 | 60 | 15 | 60 | 30 | Good |
| | | Substituted | | | Butyrolactone | solvent | | | | | Methyl- | | | | | | | |
| | | morpholine | | | | | | | | | pyrroli- | | | | | | | |
| | | | | | | | | | | | done | | | | | | | |
| Example 33 | N-Methylmorpholine | N- | 116 | 6.4 | γ- | Ester | 204 | 1.3 | 88 | 20 | N- | 50 | 92 | 60 | 15 | 60 | 10 | Good |
| | | Substituted | | | Butyrolactone | solvent | | | | | Vinyl-2- | | | | | | | |
| | | morpholine | | | | | | | | | pyrroli- | | | | | | | |
| | | | | | | | | | | | done | | | | | | | |

The aforementioned results indicate that the porous polyimide films obtained from the polyimide precursor solutions of Examples have higher open pore ratios and lower resistances than the porous polyimide films obtained from the polyimide precursor solutions of Comparative Examples.

This indicates that, compared to Comparative Examples, polyimide films having low resistance values are obtained from the polyimide precursor solutions of Examples.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A polyimide precursor solution comprising:
a polyimide precursor;
particles; and
a water-based solvent that contains an amine compound (A), an organic solvent (B) other than the amine compound (A) and amide compounds, and water,
wherein a boiling point of the organic solvent (B) is higher than a boiling point of the amine compound (A), and is 200° C. or higher and 300° C. or lower.

2. The polyimide precursor solution according to claim 1, wherein a difference between the boiling point of the amine compound (A) and the boiling point of the organic solvent (B) (boiling point of organic solvent (B)−boiling point of amine compound (A)) is 10° C. or more and 200° C. or less.

3. The polyimide precursor solution according to claim 2, wherein the difference between the boiling point of the amine compound (A) and the boiling point of the organic solvent (B) (boiling point of organic solvent (B)−boiling point of amine compound (A)) is 50° C. or more and 185° C. or less.

4. The polyimide precursor solution according to claim 1, wherein the organic solvent (B) is at least one selected from the group consisting of ketone solvents, ester solvents, and hydrocarbon solvents.

5. The polyimide precursor solution according to claim 2, wherein the organic solvent (B) is at least one selected from the group consisting of ketone solvents, ester solvents, and hydrocarbon solvents.

6. The polyimide precursor solution according to claim 3, wherein the organic solvent (B) is at least one selected from the group consisting of ketone solvents, ester solvents, and hydrocarbon solvents.

7. The polyimide precursor solution according to claim 1, wherein the organic solvent (B) is at least one selected from the group consisting of ketone solvents and ester solvents.

8. The polyimide precursor solution according to claim 2, wherein the organic solvent (B) is at least one selected from the group consisting of ketone solvents and ester solvents.

9. The polyimide precursor solution according to claim 3, wherein the organic solvent (B) is at least one selected from the group consisting of ketone solvents and ester solvents.

10. The polyimide precursor solution according to claim 1, further comprising an amide compound having a pyrrolidone structure and a boiling point of 100° C. or higher and 300° C. or lower.

11. The polyimide precursor solution according to claim 2, further comprising an amide compound having a pyrrolidone structure and a boiling point of 100° C. or higher and 300° C. or lower.

12. The polyimide precursor solution according to claim 3, further comprising an amide compound having a pyrrolidone structure and a boiling point of 100° C. or higher and 300° C. or lower.

13. The polyimide precursor solution according to claim 4, further comprising an amide compound having a pyrrolidone structure and a boiling point of 100° C. or higher and 300° C. or lower.

14. The polyimide precursor solution according to claim 5, further comprising an amide compound having a pyrrolidone structure and a boiling point of 100° C. or higher and 300° C. or lower.

15. The polyimide precursor solution according to claim 1, wherein the boiling point of the amine compound (A) is 60° C. or higher and 150° C. or lower.

16. The polyimide precursor solution according to claim 15, wherein the amine compound (A) is at least one selected from the group consisting of N-substituted morpholines, trialkylamines, and tertiary amino alcohols.

17. The polyimide precursor solution according to claim 1, wherein an amount of the particles contained relative to a solid content of the polyimide precursor solution is 30 vol % or more and 80 vol % or less.

18. The polyimide precursor solution according to claim 1, wherein an amount of the organic solvent (B) contained relative to the amine compound (A) is 1 mass % or more and 30 mass % or less.

19. A porous polyimide film production method comprising:
forming a coating film by applying the polyimide precursor solution according to claim 1 to a substrate;
forming a dry film by drying the coating film; and
forming a polyimide film by imidizing the polyimide precursor in the dry film by firing the dry film, forming the polyimide film including removing the particles.

20. A porous polyimide film produced by the porous polyimide film production method according to claim 19.
